(19) United States
(12) Patent Application Publication
(10) Pub. No.: US 2017/0023738 A1
(43) Pub. Date: Jan. 26, 2017

(54) DISPLAY PANEL AND DRIVING METHOD THEREOF, AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yang You, Beijing (CN); Kaixuan Wang, Beijing (CN)

(21) Appl. No.: 15/135,429

(22) Filed: Apr. 21, 2016

(30) Foreign Application Priority Data
Jul. 23, 2015 (CN) 201510437808.0

(51) Int. Cl. G02B 6/293

(52) U.S. Cl. CPC G02B 6/29389

(57) ABSTRACT

A display panel includes a plurality of input optical paths for transmitting optical waves along a first direction, each of the input optical paths including a light source, a plurality of multimode waveguides and a plurality of circulators, wherein the light source is connected to an input end of the input optical path, and the multimode waveguides and the circulators are provided alternatingly in the input optical path. The display panel further includes a plurality of output optical paths, each output optical path connected to one of the plurality of circulators in one of the input optical paths, respectively, for transmitting optical waves along a second direction, each of the output optical paths including a single-mode waveguide connected to the circulator through an optical filter, the single-mode waveguide configured to output an optical wave filtered by the optical filter.

### CROSS REFERENCE TO RELATED APPLICATIONS

This application claims the benefit and priority of Chinese Patent Application No. 201510437808.0, filed on Jul. 23, 2015, the entire content of which is incorporated herein by reference.

### BACKGROUND

The embodiments of the present disclosure relate to a display panel and a driving method thereof, and a display device.

Currently, displays popular in the market are mainly Liquid Crystal Displays (LCDs) and Light-Emitting Diode (LED) displays. The LED display is a flat panel display composed of a plurality of small LED module panels. It is widely used due to the advantages such as high brightness, low working voltage, little power consumption, large scale and long service life. The LCD is constructed by disposing a liquid crystal cell between two parallel glass substrates, wherein a lower glass substrate is provided with Thin Film Transistors (TFTs) and an upper glass substrate is provided with color filters, and the rotation direction of liquid crystal molecules is controlled through the signal and the voltage change of the TFT, so as to control the emergence of polarized light at each pixel point for the purpose of displaying.

However, since the LCD achieves displaying by adding liquid crystals between the TFT substrate and the color film substrate, the cost is high and the process is complex. When the resolution of an LCD needs to be increased, a quality level of the process and equipment of the LCD must be improved, increasing the cost of the LCD. In addition, although the LED display has advantages such as high brightness and firmness, its definition is poor, i.e., the resolution is low, and a good effect can only be achieved in the event of being viewed at a large distance.

The resolution of display panels can typically only be improved by techniques that result in increasing the production cost.

### BRIEF DESCRIPTION

This section provides a general summary of the embodiments described herein, and is not a comprehensive disclosure of the full scope or all of the features of the present disclosure.

The embodiments described herein provide a display panel and a driving method thereof, and a display device, which adopt optical elements with low costs to reduce the production cost and improve the resolution of the display panel.

In one embodiment, a display panel includes a plurality of input optical paths for transmitting optical waves along a first direction, each of the input optical paths being provided with a light source, a plurality of multimode waveguides and a plurality of circulators. The light source is provided at an input end of the input optical path, and the multimode waveguides and the circulators are provided alternatingly in the input optical path. A plurality of output optical paths are connected to the circulators in each of the input optical paths, respectively, for transmitting optical waves along a second direction, each of the output optical paths being provided with a single-mode waveguide which is connected to the circulator through an optical filter and used to output optical wave filtered by the optical filter.

In the display panel provided by the embodiments described herein, the number of input optical paths which transmit optical waves along a first direction may be severed as the number of row pixels, and the number of output optical paths which transmit optical waves along a second direction connected to the same input optical path may be used as the number of column pixels. Thus, the resolution of the display panel can be improved by setting the number of input optical paths and the number of output optical paths on the same input optical path. In addition, since the embodiments described herein adopt the optical elements with low production costs, specifically, take the multimode waveguide, the circulator, the optical filter and the single-mode waveguide as the main structure of the display panel, without needing to use elements with high costs such as liquid crystal, back light unit, etc., the production cost of the display panel can be decreased. Thus, the display panel provided by the embodiments described herein not only decreases the production cost thereof, but also improves the resolution thereof.

In one example, the first direction and the second direction are perpendicular to each other.

In one example, the light source is a laser which can output a plurality of optical waves with different wavelengths.

The laser inputs the optical waves with different wavelengths to the output optical path, so as to provide optical waves with different wavelengths output from the output optical path to the pixel unit for displaying.

In one example, the wavelengths of the optical waves output from the laser range from 390 to 770 nm.

In one example, the single-mode waveguide is a single-mode rectangular waveguide, of which a core layer has a diameter of 9 to 10 μm.

In one example, the multimode waveguide is a multimode rectangular waveguide, of which a core layer has a diameter of 50 to 60 μm.

In one example, the optical filter is an ultra-narrow bandwidth optical filter.

In one example, the ultra-narrow bandwidth optical filter in each of the output optical paths is corresponding to the single-mode waveguide in the output optical path.

Through one-to-one correspondence between the ultra-narrow bandwidth optical filters and the single-mode waveguides, each of the output optical paths outputs an optical wave with a different wavelength.

In one example, the laser is a laser with adjustable output power.

The laser outputs the optical waves with adjustable power to adjust the brightness of the display panel.

In another embodiment described herein, a display device includes the display panel of any of the above described embodiments or embodiments described herein.

In still another embodiment described herein, a method for driving the display panel of the embodiments described above includes the light source transmitting an optical wave to each of the input optical paths. The optical wave is transmitted in the input optical path through the multimode waveguides and arrives at the circulators. Upon the arrival of the optical wave, each of the circulators outputs a part of the optical wave transmitted therein to a next multimode waveguide so that the part of the optical wave is propagated to a next circulator in the input optical path, and outputs the other part of the optical wave to an optical filer in the output optical path so that the other part of the optical wave is filtered by the optical filer and output from a single-mode waveguide in the same output optical path. A color of the optical wave output from the single-mode waveguide corresponds to a wavelength that can be output from the optical filer.

In one example, the light source is a laser.

In another example, the plurality of input optical paths are driven serially.

According to the method for driving the display panel provided by the embodiments described herein, in each of the input optical paths which transmit optical waves along the first direction, firstly, the light source (e.g., a laser) transmits an optical wave to the input optical path. Through the input optical path, the optical wave is transmitted to each of multimode waveguides and circulators in the input optical path. Next, each of the multimode waveguides transmits the received optical wave to an adjacent circulator in the first direction, and each of the circulators transmits a part of the received optical wave to an optical filter connected to the circulator, and transmits the other part of the received optical wave to an adjacent multimode waveguide in the first direction, so that the optical wave is transmitted throughout the optical path through the circulators and multimode waveguides disposed alternatingly. In an output optical path which transmits optical waves along the second direction, the received optical wave is filtered and then transmitted by each of the optical filters to single-mode waveguides in the same output optical path, so that each of the single-mode waveguides outputs the filtered optical wave to be provided to the pixel unit for displaying, thereby achieving displaying of the display panel.

Further aspects and areas of applicability will become apparent from the description provided herein. It should be understood that various aspects of the embodiments described herein may be implemented individually or in combination with one or more other aspects. It should also be understood that the description and specific examples herein are intended for purposes of illustration only and are not intended to limit the scope of the present application.

### BRIEF DESCRIPTION OF THE DRAWINGS

The drawings described herein are for illustrative purposes only of selected embodiments and not all possible implementations, and are not intended to limit the scope of the present application.

FIG. 1 is a structural diagram of an exemplary display panel;

FIG. 2 is a flow diagram of an exemplary method for driving a display panel; and

FIG. 3 is a structural diagram of a portion of the components of the display panel in FIG. 1.

Corresponding reference numerals indicate corresponding parts or features throughout the several views of the drawings.

### DETAILED DESCRIPTION

The embodiments disclosed herein are further described in detail as follows with reference to the drawings.

The embodiments described herein provide a display panel and a driving method thereof, and a display device, which adopt optical elements with low cost to reduce the production cost and improve the resolution of the display panel.

To be noted, the display panel provided by the embodiments described herein can replace existing LCD display panels and LED display panels. The display panel provided by the embodiments described herein can be implemented by comparatively simple fabrication techniques, has a comparatively simple structure, and can provide a high resolution display without the use of conventional components such as liquid crystal and a Back Light Unit (BLU). Such a display panel can be used for high resolution flat panel displays and also for large screen displays (e.g., outdoor displays).

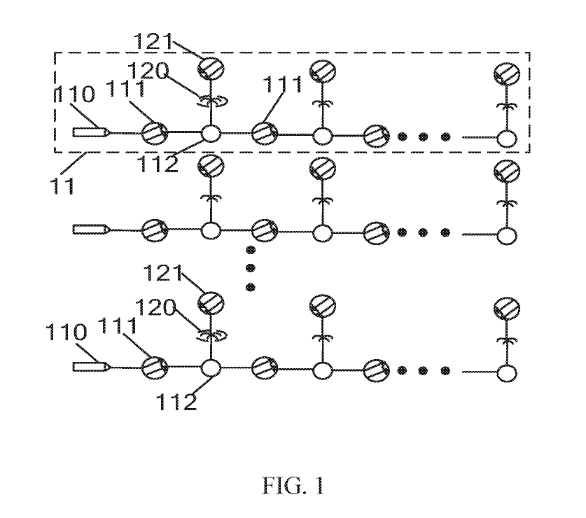

Referring to FIG. 1, a display panel provided by an exemplary embodiment includes a plurality of input optical paths 11 for transmitting optical waves along a first direction. Each of the input optical paths is provided with a laser 110, a plurality of multimode rectangular waveguides 111 and a plurality of circulators 112. The laser 110 is provided at an input end of the input optical path, and the multimode rectangular waveguides 111 and the circulators 112 are provided alternatingly. The display panel further includes a plurality of output optical paths which are connected to the circulators 112 in each input optical path, respectively, for transmitting optical waves along a second direction. Each of the output optical paths is provided with a single-mode rectangular waveguide 121 which is connected to the circulator 112 through an ultra-narrow bandwidth optical filter 120 and used to output optical waves filtered by the ultra-narrow bandwidth optical filter 120. As described above and illustrated in FIG. 1, the laser 110 is provided at the input end of each of the input optical paths, a plurality of multimode rectangular waveguides 111 and a plurality of circulators 112 are provided alternatingly in the input optical path, and a plurality of output optical paths (including the ultra-narrow bandwidth optical filter 120 and the single-mode rectangular waveguide 121) are connected to the plurality of circulators 112 in the input optical paths, respectively. In each of the input optical paths, an optical wave emitted from the laser 110 may be propagated to the circulator 112 via the multimode rectangular waveguide 111. The circulator 112 outputs a part of optical wave propagated therein to a next multimode rectangular waveguide 111 so that the part of optical wave is propagated to a next circulator, while outputting the other part of optical wave to the ultra-narrow bandwidth optical filter 120 in the output optical path. The other part of optical wave is filtered by the ultra-narrow bandwidth optical filter 120 and output by the single-mode rectangular waveguide 121. The next circulator still divides the optical wave into a part continuing to be propagated along the input optical path and a part to be output from the output optical path. The rest is done in the same manner till the optical wave is transmitted to a tail end of the input optical path or the last output optical path.

Since the laser may emit light with different wavelengths, optical waves with expected colors (e.g., red, green and blue) may be output from the output optical path by controlling a central wavelength and bandwidth of the ultra-narrow bandwidth optical filter 120, so as to achieve a colored display of the display panel. Thus, the position of each output optical path may be separated as the position of a pixel unit. A plurality of output optical paths connected to the same input optical path, i.e., the output optical paths on a row, function as a row of pixels of the display panel, and a plurality of output optical paths connected to circulators at the corresponding positions of different input optical paths, i.e., the output optical paths on a column, may function as a column of pixels. Thus a pixel array of the display panel may be formed through the arrangement of the optical components as shown in FIG. 1.

To be noted, in the embodiments described herein, any number of input optical paths for transmitting optical waves along a first direction may be included in the display panel, and any number of output optical paths for transmitting optical waves along a second direction may be included in the display panel. In the display panel provided by the embodiments described herein, the number of input optical paths may represent the number of rows of pixels, and the number of output optical paths connected to each of the input optical paths may represent the number of columns of pixels. A product of the number of input optical paths and the number of output optical paths connected to each of the input optical paths may represent the resolution of the display panel. The optical wave input to the input optical path is corresponding to a gate scanning signal input to each row of pixels, and the optical wave output by each output optical path is corresponding to an image display signal output by each pixel, thus displaying of the display panel can be controlled by controlling the transmission of the optical waves in the input optical paths and the output optical paths.

In one embodiment, either the first direction or the second direction may be a transverse direction or a longitudinal direction. FIG. 1 illustrates a transverse direction as the first direction, and a longitudinal direction as the second direction. Of course, the directions may be arranged in other ways, and no limitation is made in the embodiments described herein.

As described above, in this embodiment, each of the input optical paths corresponds to a plurality of output optical paths, and in each of the output optical paths, an optical wave is output from a single-mode rectangular waveguide therein. The input end of each of the input optical paths is connected to a laser which outputs an optical wave to the input optical path. The multimode rectangular waveguide connected to the laser transmits the optical wave to the circulator which divides the received optical wave into two parts: one is transmitted to the ultra-narrow bandwidth optical filter connected to the circulator, and the other is transmitted to a next multimode rectangular waveguide. The ultra-narrow bandwidth optical filter filters the received optical wave and then transmits the filtered optical wave to a single-mode rectangular waveguide connected thereto, and the optical wave output from the single-mode rectangular waveguide is provided to the display panel for displaying.

In one embodiment, the first and second directions are perpendicular to each other.

Specifically, when the first direction is a transverse direction, the second direction is a longitudinal direction; and when the first direction is a longitudinal direction, the second direction is a transverse direction.

In one embodiment, the laser 110 may output a plurality of optical waves with different wavelengths.

In this embodiment, every laser outputs a plurality of optical waves having different wavelengths. Thus when the optical waves are input to an input optical path, a plurality of output optical paths connected to the same input optical path may output optical waves with different wavelengths to be supplied to the display panel for colored displaying.

In one example, the wavelengths of the optical waves output from the laser 110 are between and inclusive of 390 nanometers (nm) to 770 nm.

Specifically, the laser outputs a plurality of optical waves with different wavelengths between and inclusive of 390 nm to 770 nm.

In one embodiment, the core layer of the single-mode rectangular waveguide 121 has a diameter between and inclusive of 9 micrometers (μm) to 10 μm.

In one embodiment, the core layer of the multimode rectangular waveguide 111 has a diameter between and inclusive of 50 μm to 60 μm.

In one embodiment, the ultra-narrow bandwidth optical filters 120 in each of the output optical paths are one-to-one corresponding to the single-mode rectangular waveguides 121 in the same output optical path.

In one embodiment, the wavelength of an optical wave in each of the output optical paths filtered by the ultra-narrow bandwidth optical filter corresponds to the wavelength of an optical wave that can be output from the single-mode rectangular waveguide in the output optical path. For example, in a case where the filtering range of the ultra-narrow bandwidth optical filter is set as 390 nm to 600 nm, the range of the wavelength of an optical wave that can be output from the single-mode rectangular waveguide is between 600 nm to 770 nm when it is determined that the range of the wavelength of an optical wave that can be output from the ultra-narrow bandwidth optical filter is 600 nm to 770 nm, and no optical wave will be output from the output optical path where the single-mode rectangular waveguide is located when the range of the wavelength of an optical wave that can be output from the single-mode rectangular waveguide is 390 nm to 600 nm.

It can be appreciated that in the display panel provided in the embodiments described herein, the resolution of the display panel rises with the increase of the number of input optical paths and the number of output optical paths on each of the input optical paths. In addition, when the number of input optical paths and the number of output optical paths are determined and constant, the resolution of the display panel rises with the decrease of a difference between the wavelengths of optical waves output from every two adjacent output optical paths.

For example, if m denotes the number of input optical paths and n denotes the number of output optical paths connected to each of the input optical paths, the resolution of the display panel is the product of m and n. Assume, for the following description, that there are two display panels, wherein the number of input optical paths in a first display panel is denoted with m1, and the number of output optical paths connected to each of the input optical paths is denoted with n1; while the number of input optical paths in a second display panel is denoted with m2, and the number of output optical paths connected to each of the input optical paths is denoted with n2.

If m1>m2 and n1>n2, the resolution of the first display panel is larger than the resolution of the second display panel.

If m1=m2 and n1=n2, the resolutions of the two display panels are determined according to a difference between the wavelengths of optical waves output from every two adjacent output optical paths in the first and second display panels. When the difference between the wavelengths of optical waves output from two adjacent output optical paths is small, human eyes cannot distinguish the micro color difference, thus the resolution of the display panel can be improved. When a difference between the wavelengths of optical waves output from every two adjacent output optical paths in the first display panel is less than a difference between the wavelengths of optical waves output from every two adjacent output optical paths in the second display panel, the resolution of the first display panel is larger than the resolution of the second display panel; and when a difference between the wavelengths of optical waves output from every two adjacent output optical paths in the first display panel is more than a difference between the wavelengths of optical waves output from every two adjacent output optical paths in the second display panel, the resolution of the first display panel is smaller than the resolution of the second display panel.

In one embodiment, the laser 110 is a laser of which the output power is adjustable.

Specifically, the output power of each laser may be adjustable, and the display panel may determine the brightness thereof from the magnitude of the output power.

To be noted, in the above embodiment, the laser is used as a light source for each of the input optical paths. It will be appreciated that besides the laser, some embodiments use other types of light sources, such as light emitting diodes. In addition, the embodiments described herein are not limited to the use the optical elements such as the multimode rectangular waveguide, the single-mode rectangular waveguide and the ultra-narrow bandwidth optical filter described in the above embodiments. In alternative embodiments, other multimode waveguides, single-mode waveguides and optical filters can be used.

In the display panel provided by the embodiments described herein, the number of input optical paths which transmit optical waves along a first direction may be used as the number of row pixels, and the number of output optical paths on one input optical path, which transmit optical waves along a second direction, may be used as the number of column pixels. Thus, the resolution of the display panel can be improved by setting the number of input optical paths and the number of output optical paths on one input optical path. In addition, since the display panel provided by the embodiments described herein adopts optical elements with low production costs, i.e., using the multimode rectangular waveguide, the circulator, the ultra-narrow bandwidth optical filter and the single-mode rectangular waveguide as the main structure of the display panel, the production cost of the display panel can be decreased. Thus, the display panel provided by the embodiments described herein not only decreases the production cost thereof, but also improves the resolution thereof

According to another embodiment, a display device includes a display panel provided by any of the above embodiments.

According to still another embodiment, a driving method for a display panel is provided to drive a display panel provided by any of the above embodiments. For the sake of simplicity, the specific structure of the above display panel is omitted in the following description of the method for driving a display panel.

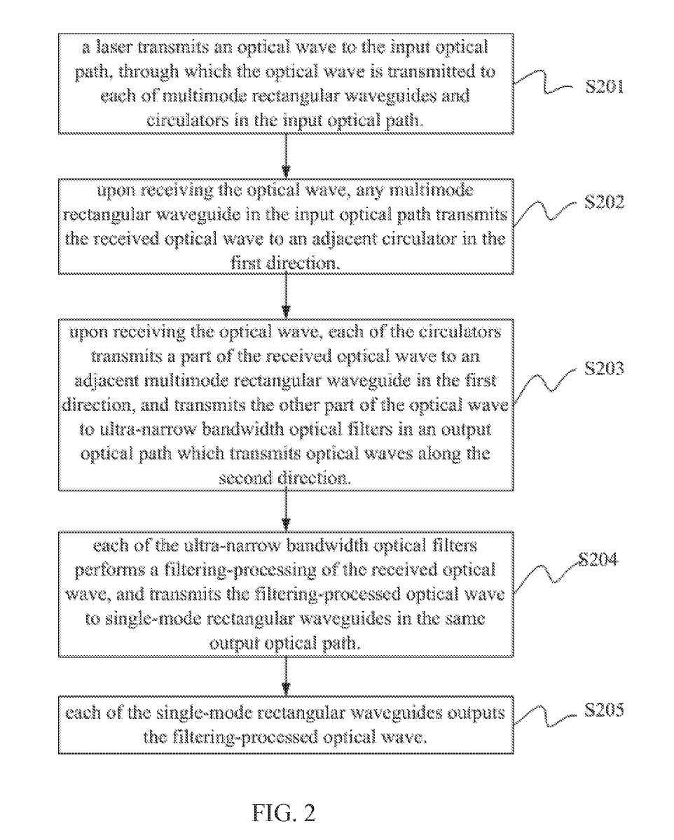

Referring to FIG. 2, a driving method for a display panel of the embodiments described herein includes the following for each input optical path transmitting optical waves along a first direction, where the first direction is a transverse direction and the optical input path transmits optical waves from left to right along the first direction.

A laser transmits (S201) an optical wave to the input optical path, through which the optical wave is transmitted to each of multimode rectangular waveguides and circulators in the input optical path.

Upon receiving the optical wave, any multimode rectangular waveguide in the input optical path transmits (S202) the received optical wave to an adjacent circulator in the first direction.

Upon receiving the optical wave, each of the circulators transmits (S203) a part of the received optical wave to an adjacent multimode rectangular waveguide in the first direction, and transmits the other part of the optical wave to ultra-narrow bandwidth optical filters in an output optical path which transmits optical waves along the second direction.

Each of the ultra-narrow bandwidth optical filters performs (S204) a filtering-processing of the received optical wave, and transmits the filtering-processed optical wave to single-mode rectangular waveguides in the same output optical path.

Each of the single-mode rectangular waveguides outputs (S205) the filtering-processed optical wave.

In the embodiments described herein, each of the lasers outputs optical waves with different wavelengths, and the ultra-narrow bandwidth optical filters are one-to-one corresponding to the single-mode rectangular waveguides in each of the output optical paths, so as to output an optical wave of a fixed wavelength.

In one embodiment, each of the input optical paths and its corresponding output optical paths (corresponding to each row pixels) may be orderly driven from top to bottom in a serial fashion.

In order to describe the driving method of the display panel more clearly, details are given as follows by taking one input optical path and two output optical paths as an example.

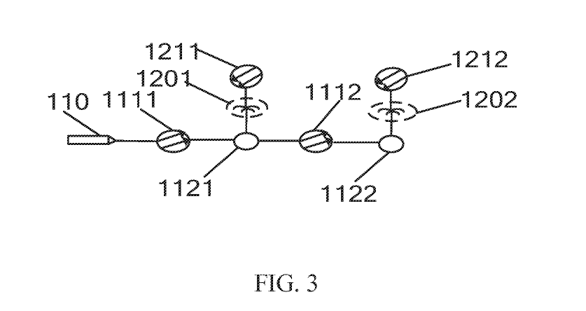

FIG. 3 illustrates a structure including one input optical path and two output optical paths. In FIG. 3, the portion of the display panel shown includes a laser 110, two multimode rectangular waveguides 1111 and 1112, two circulators 1121 and 1122, two ultra-narrow bandwidth optical filters 1201 and 1201, and two single-mode rectangular waveguides 1211 and 1212.

According to the structure of the display panel in FIG. 3, a driving method of the display panel is introduced as follows.

In one embodiment, a method for driving a display panel includes the following:

step 1: the laser 110 transmits a plurality of optical waves with different wavelengths to a multimode rectangular waveguide 1111 of the input optical path;

step 2: the multimode rectangular waveguide 1111 transmits the received optical waves with different wavelengths to a circulator 1121;

step 3: the circulator 1121 transmits a part of the received optical waves with different wavelengths to an ultra-narrow bandwidth optical filter 1201, and transmits the other part to a multimode rectangular waveguide 1112;

step 4: the ultra-narrow bandwidth optical filter 1201 performs a filtering-processing of the part of the received optical wave, and outputs an optical wave with a fixed wavelength to a single-mode rectangular waveguide 1211;

step 5: the single-mode rectangular waveguide 1211 outputs the optical wave with a fixed wavelength;

step 6: the multimode rectangular waveguide 1112 transmits the received optical waves with different wavelengths to a circulator 1122;

step 7: the circulator 1122 transmits a part of the received optical waves with different wavelengths to an ultra-narrow bandwidth optical filter 1202, and transmits the other part to a next multimode rectangular waveguide (not illustrated) connected to the circulator;

step 8: the ultra-narrow bandwidth optical filter 1202 performs a filtering-processing of the received optical wave, and outputs an optical wave with a fixed wavelength to a single-mode rectangular waveguide 1212;

step 9: the single-mode rectangular waveguide 1212 outputs the optical wave with a fixed wavelength.

The rest is done in the same manner till the last output optical path connected to the input optical path.

To be noted, steps 4 and 6 can be performed simultaneously, and their sequences are not fixed, i.e., step 6 may also be performed before step 4.

According to the method for driving the display panel provided by the embodiments described herein, in each of the input optical paths which transmit optical waves along the first direction, firstly, the laser transmits an optical wave to the input optical path, through which the optical wave is transmitted to each of multimode rectangular waveguides and circulators in the input optical path. Each of the multimode rectangular waveguides transmits the received optical wave to a next circulator in the first direction, and each of the circulators transmits the received optical wave to an ultra-narrow bandwidth optical filter connected to the circulator and to a next multimode rectangular waveguide in the first direction, so that the optical wave signal is transmitted throughout the optical path through the circulators and multimode rectangular waveguides disposed at intervals (alternatingly). In an output optical path which transmits optical waves along the second direction, each of the ultra-narrow bandwidth optical filters filter the received optical wave and transmit the filtered optical wave to a single-mode rectangular waveguide in the same output optical path, so that each of the single-mode rectangular waveguides outputs the filtered optical wave to be provided to the pixel unit for displaying, thereby achieving displaying by the display panel.

To be noted, as used in the embodiments described herein, the singular forms “a,” “an” and “the” include plural referents unless the context clearly dictates otherwise. Thus, for example, reference to “a laser” may include two or more lasers, and the like. In addition, the terms “comprising,” “including,” “containing” and “having” are intended to be inclusive and mean that there may be additional elements other than the listed elements.

The foregoing description has been provided for purpose of illustration and description. It is not intended to be exhaustive or to be limiting. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the present disclosure, and all such modifications are included within the scope of the present disclosure herein.

1. A display panel, comprising:
a plurality of input optical paths for transmitting optical waves along a first direction, each of the input optical paths including a light source, a plurality of multimode waveguides and a plurality of circulators, wherein the light source is connected to an input end of the input optical path, and the multimode waveguides and the circulators are provided alternatingly in the input optical path; and
a plurality of output optical paths, each output optical path connected to one of the plurality of circulators in one of the input optical paths, respectively, for transmitting optical waves along a second direction, each of the output optical paths including a single-mode waveguide connected to the circulator through an optical filter, the single-mode waveguide configured to output an optical wave filtered by the optical filter.

2. The display panel according to claim 1, wherein the first direction and the second direction are perpendicular to each other.

3. The display panel according to claim 1, wherein the light source is a laser which can output a plurality of optical waves with different wavelengths.

4. The display panel according to claim 3, wherein the wavelengths of the plurality of optical waves output from the laser are between and inclusive of 390 nanometers (nm) to 770 nm.

5. The display panel according to claim 1, wherein the single-mode waveguide is a single-mode rectangular waveguide including a core layer having a diameter between and inclusive of 9 micrometers (μm) to 10 μm.

6. The display panel according to claim 1, wherein the multimode waveguide is a multimode rectangular waveguide including a core layer having a diameter between and inclusive of 50 micrometers (μm) to 60 μm.

7. The display panel according to claim 1, wherein the optical filter is an ultra-narrow bandwidth optical filter.

8. The display panel according to claim 7, wherein the ultra-narrow bandwidth optical filter corresponds to the single-mode waveguide in the output optical path.

9. The display panel according to claim 3, wherein the laser is a laser with adjustable output power.

10. A display device, comprising:
a display panel comprising:
a plurality of input optical paths for transmitting optical waves along a first direction, each of the input optical paths including a light source, a plurality of multimode waveguides and a plurality of circulators, wherein the light source is provided at connected to an input end of the input optical path, and the multimode waveguides and the circulators are provided alternatingly in the input optical path; and
a plurality of output optical paths, each output optical path connected to one of the plurality of circulators in each of the input optical paths, respectively, for transmitting optical waves along a second direction, each of the output optical paths including a single-mode waveguide connected to the circulator through an optical filter, the single-mode waveguide configured to output an optical wave filtered by the optical filter.

11. The display device according to claim 10, wherein the first direction and the second direction are perpendicular to each other.

12. The display device according to claim 10, wherein the light source is a laser which can output a plurality of optical waves with different wavelengths.

13. The display device according to claim 10, wherein the single-mode waveguide is a single-mode rectangular waveguide including a core layer having a diameter between and inclusive of 9 micrometers (μm) to 10 μm.

14. The display device according to claim 10, wherein the multimode waveguide is a multimode rectangular waveguide including a core layer having a diameter between and inclusive of 50 micrometers (μm) to 60 μm.

15. The display device according to claim 10, wherein the optical filter is an ultra-narrow bandwidth optical filter.

16. A method for driving a display panel, the display panel comprising:
a plurality of input optical paths for transmitting optical waves along a first direction, each of the input optical paths including a light source, a plurality of multimode waveguides and a plurality of circulators, wherein the light source is connected to an input end of the input optical path, and the multimode waveguides and the circulators are provided alternatingly in the input optical path; and
a plurality of output optical paths, each output optical path connected to one of the plurally of circulators in each of the input optical paths, respectively, for transmitting optical waves along a second direction, each of the output optical paths including a single-mode waveguide connected to the circulator through an optical filter, the single-mode wave guide configured to output an optical wave filtered by the optical filter, the method comprising:
transmitting an optical wave to each of the plurality of input optical paths using the light source;
guiding the optical wave transmitted in each of the plurality of input optical paths through the respective plurality of multimode waveguides to the respective plurality of circulators in each optical input path of the plurality of optical input paths;
outputting, by at least one circulator of the respective plurality of circulators, a first part of the received optical wave to a subsequent multimode waveguide of the respective plurality of multimode waveguides, wherein the subsequent multimode waveguide propagates the first part of the optical wave to a subsequent circulator of the respective plurality of circulators;
outputting, by the at least one circulator of the respective plurality of circulators, a second part of the received optical wave to the optical filter in the output optical path;
filtering, by the optical filter, the second part of the received optical wave; and
outputting, by the single-mode waveguide in the output optical path, the second part of the received optical wave filtered by the optical filter, wherein a color of the optical wave output from the single-mode waveguide corresponds to a wavelength allowed to pass through the optical filter.

17. The method according to claim 16 further comprising driving each of the plurality of input optical paths serially using the light source.
